(19) United States
(12) Patent Application Publication
(10) Pub. No.: US 2011/0171502 A1
(43) Pub. Date: Jul. 14, 2011

(54) VARIABLE CAPACITY CELL ASSEMBLY

(75) Inventors: Ryan J. Kottenstette, San Francisco, CA (US); Eugene Berdichevsky, Menlo Park, CA (US); Constantin I. Stefan, San Jose, CA (US); Gregory Alan Roberts, Oakland, CA (US); Song Han, Foster City, CA (US); Yi Cui, Stanford, CA (US)

(73) Assignee: AMPRIUS, INC., Menlo Park, CA (US)

(21) Appl. No.: 13/004,737

(22) Filed: Jan. 11, 2011

Related U.S. Application Data
(60) Provisional application No. 61/294,002, filed on Jan. 11, 2010.

(51) Int. Cl. H01M 10/42; H01M 10/04; H01M 10/26; H02J 7/04

(52) U.S. Cl. 429/49; 29/623.1; 29/623.2; 320/162

(57) ABSTRACT

Electrochemical cells containing nanostructured negative active materials and composite positive active materials and methods of fabricating such electrochemical cells are provided. Positive active materials may have inactive components and active components. Inactive components may be activated and release additional lithium ions, which may offset some irreversible capacity losses in the electrochemical cells. In certain embodiments, the activation releases lithium ion having a columbic content of at least about 400 mAh/g based on the weight of the activated material.

### CROSS-REFERENCE TO RELATED APPLICATIONS

This application claims the benefit of U.S. Provisional Patent Application No. 61/294,002, filed on Jan. 11, 2010, entitled “VARIABLE CAPACITY CELL ASSEMBLY,” which is incorporated herein by reference in its entirety for all purposes.

### BACKGROUND

The demand for high capacity rechargeable electrochemical cells is strong. Many applications, such as aerospace, medical devices, portable electronics, and automotive, require high gravimetric and/or volumetric capacity cells. Lithium ion technology represents a significant improvement in this regard. However, to date, this technology has been generally limited to graphite negative electrodes with a theoretical capacity of only about 372 mAh/g during lithiation and lithium-cobalt-oxide positive electrodes with a practical capacity of about 140 mAh/g (or about 50% of its 273 mAh/g theoretical capacity). Further, lithium-cobalt-oxide is expensive for many applications, including automotive applications.

Silicon, germanium, tin, and many other high capacity materials are attractive active materials for lithium ion cells. However, adoption of these materials has been limited by in part by high irreversible capacities exhibited during initial cycling. Certain approaches have been undertaken to limit this capacity loss. For example, arranging silicon into nanowires showed a substantial reduction in pulverization.

However, introducing high capacity negative active materials into cells has, in many cases, provided only partial improvements in cells' overall capacities, in particular their gravimetric capacities. Part of the challenge results from the fact that the benefit from high capacity negative electrodes is diluted when they are paired with conventional positive electrode materials, which still provide relatively low gravimetric capacities. A conventional battery design calls for matching relative capacities of the positive and negative electrodes, leading to a situation wherein the benefit to the overall cell of a high capacity electrode, whether positive or negative, becomes less significant as the mass of the cell is increasingly dedicated to the electrode with lower capacity.

Overall, there is a need for improved applications of high capacity active materials in battery electrodes that minimize the drawbacks described above.

### SUMMARY

The present invention provides novel combinations of high capacity materials for positive and negative electrodes in lithium ion cells. A cell is assembled with a positive electrode that includes a composite active material having an active component and an inactive component. The inactive component can be later activated to provide additional lithium intercalation sites on the positive electrode. The activation process also leads to release of additional lithium ions available for cycling. A negative electrode includes a high capacity active material that is configured to accommodate the additional lithium ions released during the activation.

In certain embodiments, the amount of lithium ions released during the activation exceeds an increase in the positive electrode capacity that also results from the activation (i.e., conversion of the inactive component into an active form). Such excess of lithium ions is accommodated by high capacity negative active materials. In certain embodiments, the excess of lithium ions created during activation compensates for at least some of lithium losses in the negative electrode (e.g., SEI layer formation, irreversible trap of lithium by negative active materials, etc.).

Provided is an electrochemical cell including a negative electrode containing a nanostructured high capacity active material and a positive electrode containing a composite active material having an inactive component and an active component. The inactive component is convertible to the active component when activated. The activation may involve a release of lithium ions having a columbic content of at least about 100 mAh/g based on the weight of the converted inactivate component. In more specific embodiments, the activation involves a release of lithium ions having a columbic content of at least about 300 mAh/g based on the weight of the inactive component. The amount of the inactive component in the positive electrode prior to activation may be sufficient to approximately match the irreversible lithium insertion capacity of the negative electrode. In certain embodiments, a stoichiometric ratio of the active component to the inactive component prior to the activation is between about 1/10 and 10.

The active component may be in the form of LiMO₂, M representing one or more ions with an average oxidation state of three. Examples of these ions include vanadium (V), manganese (Mn), iron (Fe), cobalt (Co), and nickel (Ni). The inactive component may be in the form of Li₂M′O₃, M′ representing one or more ions with an average oxidation state of four. Examples of these ions include manganese (Mn), titanium (Ti), zirconium (Zr), ruthenium (Ru), rhenium (Re), and platinum (Pt).

In certain embodiments, the nanostructured active material includes silicon or more specifically silicon-containing nanowires that are substrate rooted to a conductive substrate. The nanostructured active material may include a core and a shell such that the material of the core is different from the material of the shell. In certain embodiments, the nanostructured active material includes structures having an average aspect ratio of at least about 100 in a fully discharged state. In the same or other embodiments, the nanostructured active material includes structures having an average cross-section dimension of between about 1 nanometer and 300 nanometers in a fully discharged state. The nanostructured active material may include structures having an average length of at least about 100 micrometer in a fully discharged state.

In certain embodiments, the nanostructured active material forms a layer having a porosity of less than about 75 percent. The negative electrode has a capacity to sufficient to lithiate all lithium ions available for transfer between the two electrodes after the activation of the inactive component.

Provided also a method of fabricating an electrochemical cell including a negative electrode having a nanostructured active material and a positive electrode having a composite active material. The composite material in turn includes an inactive component and an active component. The method involves activating at least a fraction of the inactive component by converting the fraction into an active form. This activation is accompanied by release of lithium ions having a columbic content of at least about 100 mAh/g based on the weight of the fraction. The negative electrode may include an irreversibly inserted amount of lithium that is no less than the released lithium ions. At least a fraction of the irreversibly inserted amount of lithium ions may be inserted into the negative electrode during the activation. In certain embodiments, the nanostructured active material has a reversible lithium insertion capacity of at least about 700 mAh/g and an irreversible lithium insertion capacity of at least about 200 mAh/g after at least 20 cycles.

The method may also involve aligning the negative electrode relative to the positive electrode to form an assembly selected from the group consisting of a jellyroll and a stack and encapsulating the assembly into a case. The activation is performed after the encapsulation of the assembly. The activation may involve charging the electrochemical cell to at least about 4.4V. The activation may be performed after at least one cycle of the electrochemical cell.

Provided also is a battery pack that includes an electrochemical cell in accordance with any one of the above claims.

These and other features of the present invention will be presented in more detail in the following specification of the invention and the accompanying figures, which illustrate by way of example the principles of the invention.

### BRIEF DESCRIPTION OF THE DRAWINGS

FIG. 1 illustrates an example of a lithium ion cell in accordance with certain embodiments.

FIG. 2 illustrates an example of a method for fabricating an electrochemical cell in accordance with certain embodiments.

FIG. 3 illustrates positive and negative electrode voltage profiles for a conventional cell with the negative active materials substantially free from lithium ions during the complete discharge.

FIG. 4 illustrates positive and negative electrode voltage profiles for a cell with the negative active materials containing some lithium ions during the complete discharge in accordance with certain embodiments.

FIGS. 5A-B are a top schematic view and a side schematic view of an illustrative electrode arrangement in accordance with certain embodiments.

FIGS. 6A-B are a top schematic view and a perspective schematic view of an illustrative round wound cell in accordance with certain embodiments.

FIG. 7 is a top schematic view of an illustrative prismatic wound cell in accordance with certain embodiments.

FIGS. 8A-B are a top schematic view and a perspective schematic view of an illustrative stack of electrodes and separator sheets in accordance with certain embodiments.

FIG. 9 is a schematic cross-section view of an example of a wound cell in accordance with embodiments.

FIG. 10 is an illustrative discharge capacity profile for a cell going through initial formation cycling and activation cycling in accordance with certain embodiments.

### DETAILED DESCRIPTION OF EXAMPLE EMBODIMENTS

In the following description, numerous specific details are set forth in order to provide a thorough understanding of the present invention. The present invention may be practiced without some or all of these specific details. In other instances, well known process operations have not been described in detail to not unnecessarily obscure the present invention. While the invention will be described in conjunction with the specific embodiments, it will be understood that it is not intended to limit the invention to the embodiments.

### I. INTRODUCTION

Many applications require high capacity cells that also have long cycle lives and are capable of operating at high currents (charge and discharge). For example, electrical vehicles would benefit from cells that are light weight (to minimize the overall weight of the vehicle for performance, safety, economy, and other reasons), small (to increase an interior space available for passengers), have a long cycle life (to increase battery replacement intervals), and operate at high currents (to perform well during vehicle acceleration and breaking).

Conventional lithium ion cells that found some use in automotive applications have graphite based negative electrodes and lithium-cobalt-oxide or lithium-iron-phosphate based positive electrodes. Unfortunately, these materials deliver relatively capacities. For example, a specific energy density of the currently available cells reaches only about 225 Wh/g, for leading consumer electronics cells. This value is significantly lower for Hybrid Electrical Vehicle (HEV) cells. It is highly desirable to increase this and other performance characteristics of the cells.

The overall cell capacity is primarily a function of the positive electrode capacity and the negative electrode capacity. Generally, capacities of each electrode are matched (e.g., a negative electrode capacity is substantially the same or slightly higher than the positive electrode capacity) to maximize cell's overall capacity (i.e., minimize amounts of active materials that can not used during cycling). Therefore, using a high capacity active material on one electrode but not another has a limited effect.

Separately, many conventional lithium ion cell electrode active materials suffer from substantial irreversible capacity losses, which indicate that some active material either degrades or is not used.

It has been unexpectedly found that matching certain positive and negative active materials leads to a substantial energy density increase and improves other performance characteristic of lithium ion cells. In many instances these increases were found to be much larger than individual contributions from each one of the active materials. For example, substituting graphite particles with silicon nanowires on the negative electrode leads to an increase in energy density of about 40%, when a conventional lithium-cobalt-oxide positive active material is used. In another example, substituting lithium-cobalt-oxide on a positive electrode with a composite lithium-manganese-oxide based material leads to an increase in energy density of about 25%, when a conventional graphite based negative active material is used. Yet, substituting both the positive active material (e.g., replacing a lithium-cobalt-oxide based positive with a composite lithium-manganese-oxide based material) and the negative active material (e.g., replacing graphite with silicon nanowires) is expected to double the energy density.

Synergistic effects, such as the one described above, come from matching specific positive and negative electrode materials having complimentary “activation” characteristics. For example, it has been found that a composite lithium-manganese-oxide based positive material can be activated under certain conditions, releasing additional lithium ions and providing additional insertion sites. The composite material initially includes an inactive component and an active component. The inactive component is needed to stabilize the entire structure of the positive active material during fabrication, which may include some initial cycling. Similarly, the negative electrode material may be said to undergo “activation.” Initial cycling may involve substantial capacity losses due to SEI layer formation, changes in morphological structures, and other reasons. Some losses result in fewer lithium ions available for cycling, e.g., when lithium is consumed during SEI layer formation.

As mentioned above, a composite positive active material may be activated resulting in at least a fraction of the inactive portion converted into the active form. In a particular embodiment, the inactive component includes Li₂MnO₃ which transforms into active MnO₂ when a cell is charged to at least about 4.4V (relative to lithium metal). During activation, in this example, two lithium ions are released by each Li₂MnO₃ molecule resulting in a flood of free lithium ions in the cell coupled with a substantial increase in the charge capacity.

During the subsequent discharge (i.e., the discharge half-cycle immediately following the activation), the newly created active MnO₂ structure accepts only one lithium ion per molecule. Additional lithium ions can be also used to compensate for lithium ions losses resulting from SEI layer formation and other reasons and, in certain embodiments, lead to increases in a cell capacity beyond that attributable to creation of additional insertion sites on the positive electrode during activation. For example, a cell may operate at conditions where the active portion of the positive electrode is not completely used during cycling prior to activation because some lithium ions have been irreversibly trapped in the negative electrode (due to, e.g., SEI layer formation) and not available for cycling.

In certain embodiments, a negative active material provides an additional storage capacity (reversible and/or irreversible) for lithium ions that may not be immediately used in cycling right after the activation. For example, the activation may result in more lithium ions available in the cell than can be intercalated into the positive electrode (both the active portion and the activated part). In this example, any excess of lithium ions may remain lithiated (possibly irreversibly) in the negative electrode.

The fractional utilization of electrode materials (i.e., the fraction of available lithium ions used for electrochemical energy conversion) in the cell is partially controlled by adjusting charge and discharge cut-off voltages. In certain embodiments, the discharge cut-off voltage may be increased in cycles immediately after the activation, such that more lithium ions remain in the negative electrodes than before the activation. Further, as some lithium ions continue being irreversibly consumed (via, e.g., SEI layer formation during subsequent cycles), the cut of voltage may be adjusted to maintain the cell capacity at the level allowed by the capacity of the positive electrode.

A brief description of a lithium ion cell example is presented below to provide a context for various embodiments of the present invention. A lithium ion battery, which is sometimes referred to as a cell pack or a battery pack, includes one or more lithium ion electrochemical cells, each containing electrochemically active materials. In addition to the cells, a lithium ion battery may also include a power management circuit to control balance power among multiple cells, control charge and discharge parameters, ensure safety (thermal and electrical runaways), and other purposes. Individual cells may be connected in series and/or in parallel with each other to form a battery with appropriate voltage, power, and other characteristics.

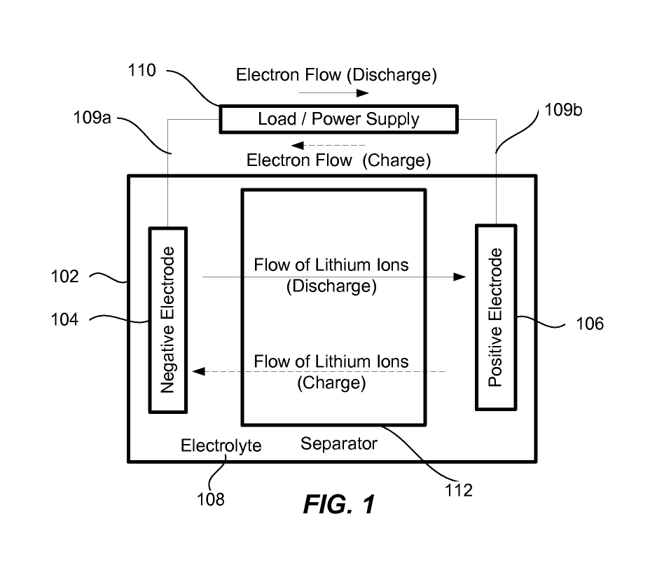

FIG. 1 is a simplified schematic depiction of a typical lithium ion cell 100 including a negative electrode 104 (sometimes referred to as an anode) and a positive electrode 106 (sometimes referred to as a cathode). The cell 100 may also include a separator 112 interposed between the positive electrode 106 and a negative electrode 104 and an electrolyte 108 carrying lithium ions between the two electrodes. In commercial applications, some cell components may be enclosed in a case 102 with electrical leads or electronically conductive pathways 109a and 109b extending to the exterior of the case 102 for connecting to a power supply (for charging) and a load (during discharge). In some embodiments, portions of the case 102 may themselves serve as one or both electrical leads. For example, the bottom and side walls of the case may, together, serve as a positive terminal (effectively part of lead 109b), while a top cover, which is electrically insulated from the remainder of the case, may serve as a negative terminal (effectively part of negative lead 109a).

An electrolyte 108 may include a lithium containing salt dissolved in one or more solvents, typically non-aqueous organic solvents. Furthermore, a cell 100 may include a separator 112 for a physical and electrical separation of negative electrode 104 and positive electrode 106. Separator 112 is typically a polymeric membrane with porosity that allows lithium ions to move between the two electrodes. In certain embodiments, separator 112 itself serves as an electrolyte (effectively a solid or gel electrolyte), as in the case of lithium polymer cells, where the separator is an ionically conductive medium.

A complete cycle of a rechargeable lithium ion cell includes a charging phase and a discharging phase, sometimes referred to as charging and discharging cycles respectively. During the charging cycle, lithium ions are released from the positive electrode 106 into the electrolyte 108 together with a corresponding number of electrons into the electrical lead 109a. An externally generated electrical potential (e.g., from the power supply 110) forces the electrons to flow from the positive electrode 106 to the negative electrode 104 where they cause insertion of lithium ions drawn from the positive electrode 106 (by creating an electrochemical potential within the cell driving the ionic flow). During this process, lithium ions are carried in the electrolyte 108 and through the separator 112, if one is present, and inserted into the negative active material of the negative electrode 104.

Inserting lithium ions into the negative electrode 104 prevents formation of metallic lithium in the cell. The resulting LiₓSi_{4.4} or other insertion negative electrode can have an X ranging between, for example, about 0.1 and 1.0. An example of a combined reaction for a lithium ion cell is shown in the equation below where the left side of the equation represents the cell in the discharge state and the right side represents the charged state:

4.4 LiMnO₂+Si⇄4.4 Li_{1-X}MnO₂+Li_{4.4X}Si

It should be noted that stoichiometric coefficients in the above example are for illustrative purposes only. Amounts of active materials on the respective electrodes are determined by various factors, such as degree of charge for each electrode, irreversible capacity losses, an activation process, and may others, described throughout this document.

Controlling the applied charge voltage affects the amount of lithium ions transferred from the positive electrode 106 to the negative electrode 104. Generally, it is not desirable to transfer more lithium ions that can be inserted into the negative active material for safety reasons (e.g., to prevent lithium dendrites formation that can cause internal short). At the same time, an amount of lithium ions transferred between the electrode determines cell capacity and it is highly desirable to transfer as much lithium ions as possible.

During the discharge cycle, the negative electrode active material loses electrons and releases lithium ions into the electrolyte where they are transported to the positive electrode. Thus, during discharge, electrons flow from the negative electrode 104 to the positive electrode 106 supplying power to external load 110. The charging and discharging phases may be repeated many times in rechargeable lithium ion cells. A typical cycle-life of a lithium ion cells may be in the hundreds or thousands of cycles, as dictated by the minimum allowable capacity of the cell.

A cell capacity is determined by the number of ions (e.g., lithium ions in lithium ion cells) that could be transfer between the cell's electrodes. Capacities are typically presented in “Amp×hour” units. For example, 1 Amp×hour (or lAh) is equivalent to 3600 Coulombs or about 2.24×10²² single-charged ions (e.g., Li⁺) transferred between electrodes. A “theoretical capacity” is characterized by a maximum value of ions that could be theoretically transferred and inserted into each electrodes. Any ionic transfer that does not result in electrode insertion (and, for example, causes electroplating) does not contribute to the theoretical capacity. A :design capacity” is defined as a subset of the theoretical capacity that results from externally imposed cycling conditions (e.g., an upper cut-off voltage, a lower cut-off voltage, a rate of transfer/electrical current).

Cell's theoretical capacity may be limited by a number of factors including characteristics of the positive and negative electrodes and the number of ions available for cycling. For example, even when both electrodes have substantial insertion capacities, there may be not enough ions available in the cell to transfer between them and make use of the available insertion capacities. Such ions are referred to, in this document, as “transferable ions” and a corresponding capacity that could be theoretically provided by these transferable ions, irrespective of electrode characteristics, is referred to as a “transferable capacity”. In some situation as, for example, described above, the cell capacity is substantially the same the transferable capacity. However, in other situations, the theoretical capacity may be limited by other factors, such as the insertion capacity of one or more electrodes. In these situations, the transferable capacity may be higher than the theoretical capacity. In other words, a cell may have more transferable ions than can be inserted in at least one of the electrodes. As a result, some fraction of the available transferable ions can not be utilized (and is not transferred, as a result) and do not impact the theoretical capacity. It should be noted that the transferable capacity and, in some instances, the theoretical capacity can be impacted by irreversible processes, such formation of an SEI layer, activation of the inactive portion of the composite positive active material, and other changes in the cell.

A theoretical capacity may be also limited by the insertion capacities of the two electrodes determined by a number of insertion sites available on the electrodes. This is a measure of how many ions can be inserted into each of the electrodes. Insertion capacities can be reduced, for example, by electrode degradation. In certain embodiments as explained herein, the positive insertion capacity is increased as a result of activation.

Interplay between these transferable and insertion capacities and their impact on the theoretical capacity can be illustrated in the following examples. In some types of electrochemical cells, ions that are used to transport the charge between two electrodes may be irreversibly trapped in the cell, e.g., to form an SEI layer on the negative electrode. This irreversible trapping causes some capacity losses as evidenced by low Coulombic efficiencies during formation. Both positive and negative electrodes may have an excess of insertion sites, but there is not enough transferable ions to be inserted in these sites. Using the above definitions, the transferable capacity in this example at some point may become less than the negative and/or negative insertion capacities.

In some embodiments, a cell has more transferable ions than can be inserted in either one or both electrodes. The theoretical capacity is therefore limited by one or more of the insertion capacities. For example, a positive electrode may accommodate fewer ions than are available to be transferred. This may happen after activation of the positive material resulting in substantial increase in a number of transferable ions in the cell. When all positive insertion sites are filled, some lithium remain on the negative electrode. In this example, the transferable capacity is higher than the positive insertion capacity. If the negative insertion capacity is higher than the transferable capacity, then the theoretical capacity is the same as the positive insertion capacity. There may be some benefits, further described below, to operate an electrochemical in accordance with these embodiments.

In other embodiments, a negative electrode may accommodate fewer ions than available for transferred. When all negative insertion sites filled ions, some ions remain on the positive electrode. In this example, a transferable capacity is higher than a negative available capacity. If the positive insertion capacity is higher than the transferable capacity, then the theoretical capacity is the same as the negative insertion capacity. However, such situations are typically avoided for safety concerns.

In yet another example, both positive and negative electrodes may have fewer insertion sites than transferable ions, in which case some ions are present on both electrodes during at the both ends of the theoretical cycle. It can also be said that in this example the transferable capacity is higher than both positive and negative insertion capacities. It should be noted that the theoretical capacity in this example is less than the transferable capacity and positive and negative insertion capacities. For example, if a cell has a positive insertion capacity of 300 mAh, a negative insertion capacity of 400 mAh, and a transferable capacity of 500 mAh, then the theoretical capacity would be only 200 mAh. When such cell is fully charged, the negative electrode contains only a portion of the transferable ions, more specifically a 400 mAh equivalent. The remaining ions (a 100 mAh equivalent) are stored in the positive electrode. When the cell is fully discharged, the positive electrode can contain only the 300 mAh equivalent of transferable ions. In other words, an equivalent of 200 mAh could only be transferred between the electrodes.

The above consideration strongly influences cell design including the relative amounts of positive and negative electrode materials used to fabricate the cell. It may be desirable to maintain a balance between transferable ions and insertion sites available on each electrode, such that the transferable capacity is substantially the same as the negative and positive insertion capacities. In such scenario, no or very little active material is “wasted” to store transferable ions that could not transferred (e.g., if the transferable capacity is higher than either one or both insertion capacities) or “unused” (if one insertion capacity is higher than either the transferable capacity or the other inserion capacity). However, in certain embodiments further described below in more details, it may be preferable to have an excessive negative insertion capacity in order, for example, to prevent premature degradation of the negative electrode, improve insertion kinetics of the positive electrode, achieve a higher cell voltage over a wider state of charge range, and other benefits.

### II. ELECTRODE STRUCTURES

A. Positive Electrode

In certain embodiments, a positive electrode includes, at least initially, a composite active material having an inactive component and an active component. An active component delivers and inserts lithium ions during initial cycling under typical cycling conditions. For example, when an electrochemical cell is first assembled, the first charge capacity is determined by the available active component (in addition to the negative electrode capacity) unless the first charge is combined with the activation, in which case, some additional lithium is irreversibly released into the cell.

As explained, the composite material may form a layered structure in which the inactive component ensures stability of the entire structure during initial cycling (prior to the activation). An inactive component is typically structurally compatible with the corresponding active component. Structural compatibility may involve the ability of the active and inactive components to intermingle at the atomic level as, for example, described in U.S. Pat. No. 6,680,143 issued on Jan. 20, 2004 to Thackeray, et al., and U.S. Pat. No. 6,677,082 issued on Jan. 13, 2004 to Thackeray et al., which are incorporated herein by reference in their entireties for purposes of describing structurally compatible composite active materials. For example, both active and inactive materials have close-packed lattices and MO₆ octahedral structures, as well as similar inter-layer spacing (e.g., ˜4.7 Angstroms).

In certain embodiments, an active component is represented by a formula

LiMO₂, where M represents an ion or a combination of ions with an average oxidation state of three and corresponds to vanadium (V), manganese (Mn), iron (Fe), cobalt (Co), and nickel (Ni), or combination of thereof. Some examples include LiMnO₂, LiMn_{0.31}Ni_{0.44}Co_{0.25}O₂, LiMn_{0.256}Ni_{0.372}Co_{0.372}O₂, LiMn_{0.5}Ni_{0.5}O₂, LiMn_{0.4}Ni_{0.4}Al_{0.2}O₂, LiMn_{0.4}Ni_{0.4}Li_{0.2}O₂, LiMn_{0.5}Ni_{0.4}Li_{0.1}O₂, and LiNi_{0.8}Co_{0.2}O₂.

An inactive component may be represented by a formula Li₂M′O₃, where M′ represents an ion or a combination of ions with a average oxidation state of four and correspond to manganese (Mn), titanium (Ti), zirconium (Zr), ruthenium (Ru), rhenium (Re), platinum (Pt), or a combination thereof. Some examples include Li₂MnO₃, Li_{1.8}Mn_{0.9}Ni_{0.3}O₃, and Li₂TiO₃.

A general formula of the composite positive active material prior to the activation can be expressed as xLiMO₂·(1−x)Li₂M′O₃. In certain embodiments, prior to activation, x ranges between about 0.1 and 0.9, more specifically between about 0.5 and 0.8, or even more specifically between about 0.6 and 0.8. After activation, x can be at least about 0.5. Both the pre-activation and post-activation ratios as well as the SEI-driven demand for lithium on the negative electrode side are tunable.

Another way to characterize amounts of the active and inactive components in the positive electrode is based on their respective capacities. The baseline for such characterization may be an initial discharge capacity of the cell, a nominal discharged capacity of the cell, or an irreversible capacity of the cell. For the purposes of this document, the nominal discharge capacity is a discharge capacity after performing formation and activation cycling and when the columbic efficiencies of at least one prior cycle and at least one subsequent cycle is at least about 95%. The columbic efficiency is defined as a ratio of the discharge capacity to the previous charge capacity of the cell. Typically, a nominal discharge capacity is measure after at least several initial cycles (e.g., after 5 cycles, 10 cycles, 20 cycles, etc.). Further, the irreversible capacity is defined as a difference between the first discharge capacity and the nominal discharge capacities in a hypothetical scenario where the activation is not performed.

B. Negative Electrode

Various benefits of the positive electrodes described above can only be realized when such electrodes are combined with certain negative electrodes. For example, negative active materials may be chosen to have sufficient capacity to accommodate release of new lithium ions during the activation. Further, negative materials must be resistant to exfoliation that may be caused by insertion of materials other than lithium ions. Specifically, some positive active materials described above tend to release ions other than lithium ions (e.g., ions of the base transition metals) into the electrolyte. It has been found that conventional graphite electrodes are very susceptible, for example, to dissolved manganese ions and rapidly degrade when combined with the composite active materials containing manganese.

At the same time, activation of the positive active material and the concomitant release of additional lithium ions may be compensated by the irreversible capacity losses associated with silicon and other some other high capacity negative electrode materials. As mentioned, such irreversible capacity losses may be caused by, e.g., SEI layer formation. High surface area negative electrodes, such as nanowire negative electrodes, may result in particularly large lithium losses. Further, low electrical conductivity and large volume change of many high capacity negative active materials (e.g., silicon) may lead to residual lithium remaining on the negative electrode even during deep discharges.

In certain embodiments, a negative electrode includes one or more nanostructured materials that have high reversible capacities. A high reversible capacity may be needed to ensure that excess lithium ions released during the activation of the positive electrode can find lithiation sites on the negative electrode. In certain embodiments, the first cycle discharge capacity of the nanostructured negative electrode material is at least about 1500 mAh/g, or more specifically at least about 2000 mAh/g, even more specifically at least about 2500 mAh/g, or at least about 3000 mAh/g, or at least about 3700 mAh/g. In the same or other embodiments, the tenth cycle discharge capacity is at least about 500 mAh/g, or more specifically at least about 1000 mAh/g, even more specifically at least about 1500 mAh/g, or at least about 2000 mAh/g, or at least about 2500 mAh/g, or at least about 3000 mAh/g, or even at least about 3500 mAh/g. The above cell capacity values may be defined for certain cell operating regimes that may be characterized by, e.g., cut off voltages and current rates. In certain embodiments, the above cell capacities are specified for a discharge cut off voltage of about 150 mV, 100 mV, 50 mV, or 10 mV relative to lithium metal at between about 0.1 C and 0.5 C discharge rate.

The nanostructured active material may have an irreversible lithium insertion capacity of at least about 200 mAh/g after at least 10 cycles or more specifically at least about 300 mAh/g or even more specifically at least about 400 mAh/g.

In certain embodiments, nanostructured materials include silicon, germanium, tin, tin oxide, titanium oxide, carbon, a variety of metal hydrides (e.g., MgH₂), silicides, phosphides, carbon-silicon combinations (e.g., carbon-coated silicon, silicon-coated carbon, carbon doped with silicon, silicon doped with carbon, and alloys including carbon and silicon), carbon-germanium combinations (e.g., carbon-coated germanium, germanium-coated carbon, carbon doped with germanium, and germanium doped with carbon), carbon-tin combinations (e.g., carbon-coated tin, tin-coated carbon, carbon doped with tin, tin doped with carbon, and combinations of thereof. These negative active materials are less susceptible to exfoliation than graphite resulting in a more stable electrochemical system when combined with the composite positive active materials.

A nanostructured active material may form an active layer (e.g., on each or one side of a substrate or without a substrate) having certain thickness and porosity. Porosity is defined a ratio of a void space in the layer to the overall volume prior to the first cycle. In certain embodiments, the porosity of the active layer is at least about 10%, or more specifically at least about 20%, at least about 30%, at least about 40%, at least about 50%, or at least about 60%. In even more specific embodiments, the porosity may be at least about 75%, or more specifically at least about 90%. Greater porosity may allow more swelling of the nanostructures during cycling.

The thickness of the active layer may change during cycling. Swelling of the nanostructures may exceed the porosity of the active layer causing the layer to expand. Additionally, certain arrangements of the nanostructure may cause the active layer to increase its thickness even though some void space remains in the layer. An active layer may change its thickness by no greater than 100%, or more specifically by no greater than 50%, between charge and discharge states.

Cross-sectional shapes are generally dependent on compositions, crystallographic structures (e.g., crystalline, amorphous), sizes, deposition process parameters, and many other factors. Shapes may also change during cycling. Irregularities of cross-sectional shapes require a special dimensional characterization. For the purposes of this application, a cross-section dimension is defined as a distance between the two most separated points on a periphery of a cross-section that is transverse to the principal dimension, such as length. For example, a cross-section dimension of a cylindrical nano-rod circle is the diameter of the circular cross-section. In certain embodiments, a cross-section dimension of nanostructures is between about 1 nm and 10,000 nm. In more specific embodiments, a cross-section dimension is between about 5 nm and 1000 nm, and more specifically between 10 nm and 200 nm. Typically, these dimensions represent an average or mean across the nanostructures employed in an electrode.

In certain embodiments, nanostructures are hollow. They may be also described as tube or tube-like structures. Therefore, the cross-sectional profile of these hollow nanostructures includes void regions surrounded by annular solid regions. An average ratio of the void regions to the solid regions may be between about 0.01 and 100, more specifically between about 0.01 and 10. The cross-section dimension of the hollow nanostructures may be substantially constant along the principal dimension (e.g., typically the axis). Alternatively, the hollow nanostructures may be tapered along the principal dimension. In certain embodiments, multiple hollow nanostructures may form a core-shell arrangement similar to multiwall nanotubes.

A nanostructured active material may include different materials (both active and non-active) and distribution of these materials within the nanostructure may vary as well. For example, each material may form its own layer within a nanostructure. The nanostructure may have multiple shells. It should be understood that any number of concentric shells may be used. Furthermore, a core may be a hollow (e.g., tube-like) structure. Typically, at least one of the materials in a core-shell is an active material. In one embodiment, a core-shell structure forms nested layers in a rod or wire, where one layer is surrounded by another outer layer, e.g., forming a set of concentric cylinders. In other embodiments, each layer of the nanostructure is a sheet that is rolled around itself and other layers to form a spiral. For simplicity, each of these embodiments is referred to as a core-shell structure.

In general the dimensions and shapes of core-shell nanostructures fall into the same ranges as discussed above for single material nanostructures. In one example, the average cross-section dimension of core-shell nanostructures may be between about 1 nm and 100 μm and more specifically between about 50 nm and 5 μm. The transverse dimension (e.g., thickness or diameter) of each layer may be between about 1 nm and 10 μm and more specifically between about 10 nm and 1 μm. Of course, the thickness of one layer may different from thicknesses of other layer.

The core and the inner most shell are generally made from two different materials or from different structures of the same material. In certain embodiments, the core includes a silicon containing material, while the inner most shell includes a carbon containing material. Carbon has good electrical conductivity, lithium ion insertion properties, and mechanical strength. Carbon shells may be permeable for lithium ions (e.g., 10 nm and 1 μm thick). In certain embodiments, the carbon outer shell represents between about 1 and 5 weight percent of the entire nanostructure composition. Some lithium ions may be inserted into the carbon shell, while others may penetrate through the shell and be inserted into the silicon core. In the embodiments including multiple shells, lithium ions can further penetrate through the layer increasing the effective capacity of the nanostructures.

In certain embodiments, the core includes a carbon containing material, while the shell includes a silicon containing material. The silicon shell may be permeable to some lithium ions. Other materials may serve as the core and shell components of the structures, for example, the ones listed above.

In certain embodiments, the core and shell components include silicides and/or carbides, such as a zirconium carbide. Some of these materials may improve conductivity of the nanowires and may allow the layers of the core-shell nanostructure to expand during lithiation without destroying the overall structure of the nanowire. Some of the proposed materials that can be used in combinations with active materials in the core-shell arrangements may have good conductivity and/or be inert to the active ions in the electrolyte. Some materials, such as carbon, may provide additional lithiation sites and help to increases capacity of the overall nanowire. Amounts of materials in different layers of the core-shell arrangements may be determined based on conductivity, volume expansion, and other design considerations.

A nanostructure may be deposited as a single crystal, multiple crystals combined together, a predominantly amorphous structure, or a combination of crystals and amorphous structures. Often, initially deposited crystalline structures are later transformed into amorphous structures during initial cycling of the cell. During cycling the nanostructure is transformed into a predominantly amorphous structure. The amorphous structure may have a few remaining crystals. Often such transformation corresponds to some capacity loses.

In certain embodiments, the nanostructures are deposited in a predominantly amorphous form. Without being restricted to any particular theory, it is believed that eliminating initial structural transformation helps to reduce initial capacity loss. For example, a silicon layer of the nanostructure deposited over the carbon layer may assume a naturally amorphous state directly upon the deposition, thereby avoiding the need to convert from a crystalline to an amorphous state during an initial cycle. For example, silicon deposited over the surface of a carbon nanostructure (to form core-shell nanostructures) using a thermal CVD or PECVD method may form an amorphous silicon.

In certain embodiments, an exposed surface of the negative electrode is functionalized to increase amounts of irreversibly trapped lithium on its surface. This amount of irreversibly trapped lithium may be at least about 5%, or more specifically, at least about 10% or even at least about 20% measured relative to the negative insertion capacity. For example, if fewer positive electrode insertion sites are available than transferable ions, some of these ions need to be stored on the negative electrode and additional negative material is needed. Sometimes this ion excess is generated during activation on the positive electrode resulting in additional ions released. The amount of additional ions may exceed any additional positive insertion capacity created during such activation and any ion losses (due to, e.g., SEI layer formation). The negative active material used to store this excess of transferable ions remains “unused” or “wasted” from the capacity perspective, since the ions stored in it are not transferred and do not contribute to the theoretical capacity. Generally, such “unused” active material, whether it is present in the positive electrode or the negative electrode, needs to be minimized or eliminated. In other words, the transferable capacity should be maintained substantially the same as the positive and the negative insertion capacities. In certain embodiments, one of the three capacities (i.e., theoretical, positive insertion, negative insertion) deviates from two others by less than about 20% or, more specifically, by less than about 10%, or even more specifically by less than about 5%. However, in some embodiments further described below, this “used” material may be beneficial for certain cell performance characteristics.

A functionalized surface of the negative electrode may be used to irreversibly accommodate more lithium ions than in a conventional SEI layer. Such lithium may be trapped without effecting negative insertion capacity. More specifically, the transferable capacity is reduced in these embodiments, while the positive and negative insertion capacities remain substantially the same. For example, a thin layer (e.g., less than 20 nm or, more specifically, less than 10 nm) of oxide, nitride, carbide, hydride or other form of hydrogen termination, organic molecules, polymer coatings, carbon coatings, amorphous silicon, and other materials may be deposited on the exposed surface of the negative electrode. In particular embodiments, a negative electrode contains silicon or, more specifically, silicon nanoparticles (e.g., nanowires) and one or more functionalization layers listed above is deposited on the negative electrode.

Generally, amount of lithium trapped in SEI layers is proportional to the exposed negative electrode surface. In other words, high surface area negative electrodes tend to irreversibly trap more lithium during SEI formation as evident from lower columbic efficiencies during formation cycles.

The surface area depends on arrangement and size of the structures in the electrode. For example, two layers may contain the same volume of material, e.g., a 5 μm thick solid layer and a layer containing nanowires that are 0.1 μm in diameter and 20 μm in length and substrate rooted with 25% surface density. Yet, the layer with nanowires has the surface area about 200 times larger than the solid layer. As a result, an SEI layer forming on the layer with nanowires will irreversibly trap substantially more lithium. In certain embodiments, a ratio of the exposed surface of a portion of the active layer to the area of the substrate carrying this portion is at least about 10 or, more specifically, at least about 50, or at least about 100, or at least about 500. In the above example this ratio is about 200.

In certain embodiments, an exposed surface area of the negative electrode can be adjusted to irreversibly trap different amounts of lithium. For example, an exposed surface area may be such that any lithium that can not be transferred between positive and negative electrodes (i.e., an excessive transferable capacity) is trapped in an SEI layer or a functionalized layer or some other method. These embodiments can be used to minimize or eliminate “unused” active materials in the cell resulting, in some instances, in a theoretical capacity increase. In the above example where a cell had a positive insertion capacity of 300 mAh, a negative insertion capacity of 400 mAh, and a transferable capacity of 500 mAh, the theoretical capacity can increased from 200 mAh to 300 mAh by eliminating transferable ions equivalent to the 100 mAh transferable capacity (e.g., by trapping in an SEI layer)

The amount of exposed surface area can be controlled by changing types, sizes, and arrangement of structures in the layer. In certain embodiments, a negative active layer includes nanowires. Nanowire structures and their use in active layers are further described in U.S. patent application Ser. No. 12/437,529 filed on May 7, 2009, which is incorporated by reference herein in its entirety for purposes of describing nanowires. The exposed surface area of such active layer may be tailored by changing the nanowires' lengths, diameters, and/or surface area density.

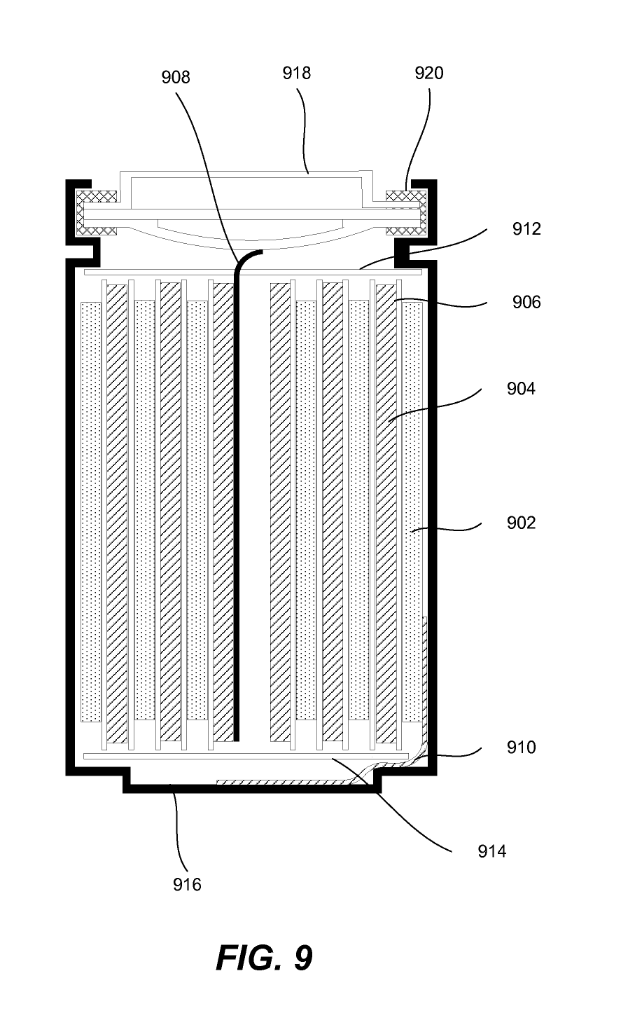

A nanowires' diameter can be adjusted during its growth and/or afterwards, e.g., by depositing another layer. For example, in a CVD-VLS process for growing substrate-rooted nanowires, the size of discrete catalyst elements on the deposited nanowire tip (e.g., drops, particles) controls the nanowire diameter. This deposition process is further explained in U.S. patent application Ser. No. 12/437,529 filed on May 7, 2009, which is incorporated by reference herein in its entirety for purposes of describing CVD-VLS nanowire growth. A specific reference is made to FIG. 9 and corresponding description in U.S. patent application Ser. No. 12/437,529. The initial size of the catalyst particles or “islands” can be achieved by dispersing pre-synthesized nanoparticles that are pre-sized to controlled dimensions (e.g., between about 5 nm and 100 nm, more specifically between about 10 nm and 50 nm) or controlling a thickness of the deposited catalyst layer that later forms catalyst “islands.” (e.g., between about 1 nm and 1000 nm, more specifically between about 10 nm and 100 nm). Generally, a thinner layer tends to generate smaller “islands”. However, surface properties may also be adjusted to create larger islands that are further apart.

In the same or other embodiments, an intermediate layer may be used to adjust interface properties between the catalyst and substrate. Various intermediate layers are described in more detail in U.S. Provisional Patent Application No. 61/260,297 entitled “INTERMEDIATE LAYERS FOR ELECTRODE FABRICATION” filed on Nov. 11, 2009, which is incorporated by reference herein in its entirety for purposes of describing intermediate layers. Additional methods for controlling the size of catalyst particles or “islands”, which may be combined with one or more of the other methods, include controlling the annealing procedure (e.g., changing temperature) and/or modifying the pressure and/or environmental influence to, e.g., change surface tension balance.

In certain embodiments, nanowires are synthesized without using catalyst. The diameter of such nanowires can be controlled by adjusting nucleation surface (e.g., surface roughness), controlling side wall deposition, and/or growing nanowires in a pre-defined space (e.g., providing a mask on the deposition surface). Nanowires may be also prepared using an etching process (e.g., etching from a solid block of silicon).

Another way to adjust the surface area is by controlling the surface roughness of the structures in the electrode layers. The surface roughness can be controlled during deposition or it can be changed later. For example, after crystalline silicon nanowires are deposited in a thermal CVD process, a layer of amorphous silicon may be deposited over the nanowires using PECVD. This subsequent process may effectively change the exposed surface area by modify the nanowires' diameters and/or surface roughness. In the same or other embodiments, surface roughness and/or nanowires diameters could be changed by etching, ablating, or otherwise chemically or physically treating the active layer. Further, an exposed surface area may be changed by adding additional structures (e.g., incorporating additional nanostructures). It should be noted that technique described above can be used on active layers that do not contain nanowires.

In certain embodiments, the exposed surface area may be reduced after forming an active layer. One way to change the exposed are is through annealing. Annealing may be performed by subjecting the electrode to high temperature and/or pressure, e.g., passing the electrode through a hot roll press.

In certain embodiments, some lithium remains on the negative electrode even when all intercalation sites on the positive electrode are filled. For example, a negative insertion capacity and a transferable capacity may both exceed the positive insertion capacity by at least about 5% or, more specifically, or more specifically by at least about 10% or even by at least about 20%. In other words, there are more lithium ions available for transfer than there are intercalations sites in the positive electrode.

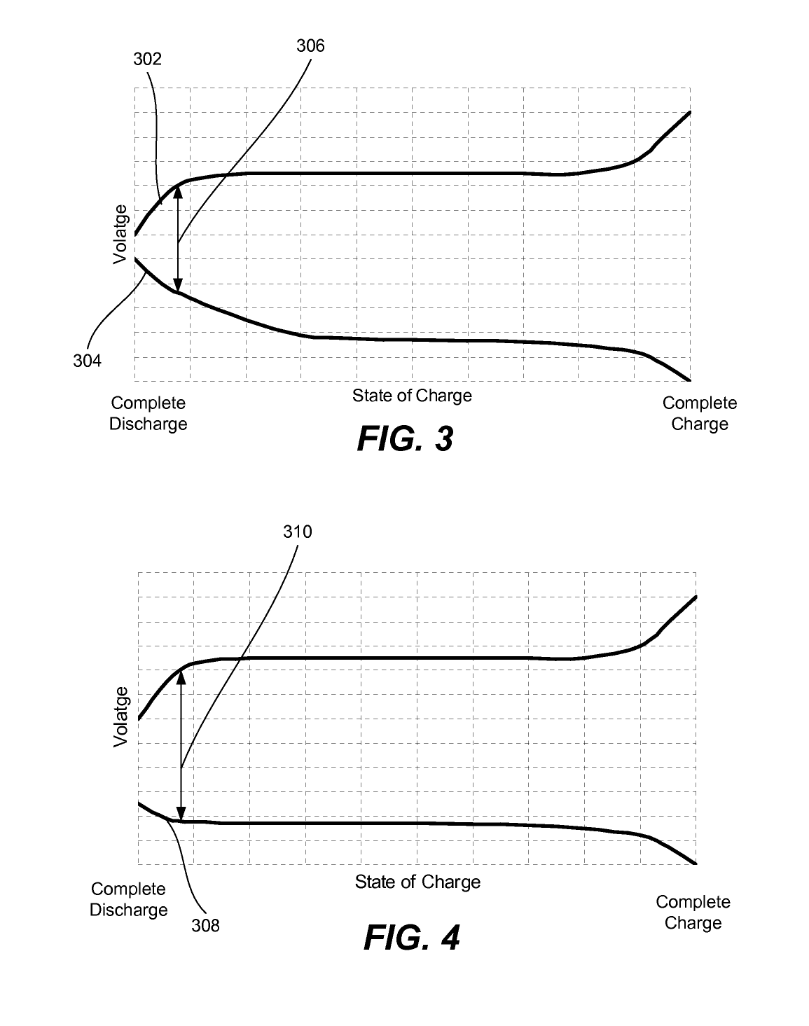

Operating such cells may provide some benefits as illustrated in FIGS. 3 and 4. These figures include examples of positive electrode voltage profiles (top curves 302 in each plot) and negative electrode voltage profiles (bottom curves 304 and 308) for two different cells. FIG. 3 corresponds to a conventional cell in which most lithium ions are removed from the negative electrode at a complete discharge states. While approaching this state, the negative electrode voltage 302 rapidly increases as it becomes more difficult to extract last remaining ions from the negative active material. At the same time, the positive electrode voltage 304 shows some decrease as the positive material gets saturated with lithium ions. The overall cell voltage 306 (i.e., the difference between the positive electrode voltage and the negative electrode voltage) rapidly decreases as the cell approaches the complete discharge state and, at some point, operating as such a low voltage becomes impractical.

FIG. 4 corresponds to a novel cell, in which some lithium remains on the negative electrode even when all positive intercalation sites are filled. Since some lithium remains on the negative electrode, its voltage 308 increases only slight in comparison to the conventional cell (line 302). The positive electrode voltage profile may be the same, as illustrated in FIGS. 3 and 4. As a result, the overall cell voltage 310 is higher at the same state of charge in the novel cell than in the conventional cell (difference 306 in FIG. 3) resulting in higher power output and a flatter voltage profile.

It should be noted that cells are typically not cycled to their theoretical limits. In other words, the upper and lower cut-off voltages are set in such a way that some lithium remains on both electrodes at both ends of such designed cycle. However, comparing voltage profiles in FIGS. 3 and 4, it can be seen that a theoretical limit of the positive electrode can be easily approached (e.g., without sacrificing an overall cell voltage drop) in novel cells represented by FIG. 4 that in conventional cell.

While novel cells require a greater quantity of negative active materials and more transferable ions than conventional cells, these characteristics can be easily achieved by combining high capacity negative active materials with a composite positive active material described above. A part of the composite positive materials is then activated releasing additional ions into the cell. Without being restricted to any particular theory, it is believed that maintaining some lithium in silicon containing negative active materials at the discharge end of the cycle helps to minimize and, in some instances, to avoid certain morphological changes in the negative active material. For example, it has been demonstrated that silicon transitions from its amorphous to its crystalline lattice structure when substantially all lithium is extracted from silicon structures. During subsequent lithiation, silicon may transition back from crystalline into amorphous morphology. This morphological change may repeat during other cycles when substantially all lithium ions are removed from silicon structures. It is believed that these changes negatively impact overall cell performance by degrading negative active materials (e.g., worsening electrical conductivity).

When some lithium remain in silicon containing negative active material, the active material remains more stable and shows improved cycling performance (e.g., cycle life). In certain embodiments, the cell is only discharged to a level at which a portion of the negative active materials corresponding to at least 5% of the negative insertion capacity still contains lithium. In more specific embodiments, this portion is at least about 10% or more specifically, at least about 20%. Lithium ion removal kinetics tends to be faster as evidence by a lower negative electrode voltage at the discharge cut-off state (line 308 in FIG. 4). Faster kinetics allow not only to receive higher power output but also to operate at higher discharge currents, which may be particular useful in certain applications like HEV.

In certain embodiments, amounts of lithium ions irreversibly trapped in an electrochemical cell or, more specifically, in an SEI layer can be controlled by modifying formation cycle conditions, such as cut-off voltages, currents, rest periods. Further, multiple charge-discharge cycles may be used during formation. For example, some lithium ions may be lost in the first cycle and then some additional lithium ions are trapped in subsequent formation cycles that are, for example, progressively deeper and/or performed at higher rates.

In the same or other embodiments, activation of the inactive portion of the composite positive active material can be performed gradually over multiple cycles. For example, a charging voltage may be gradually raised over a few cycle resulting in additional activation in these cycles.

### III. ELECTRODE ASSEMBLY

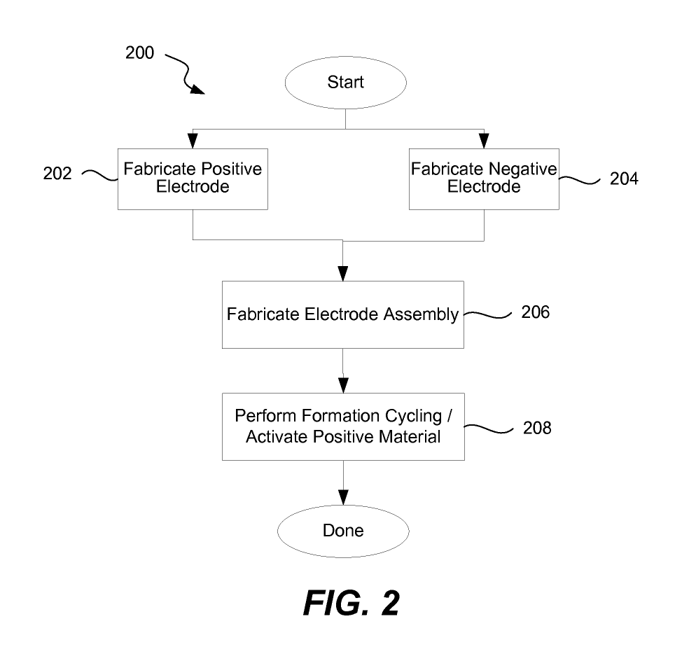

FIG. 2 illustrates an example of a process 200 for fabricating an electrochemical cell in accordance with certain embodiments. The process may start with fabricating a positive electrode containing one or more composite active materials described above (block 202) and fabricating a negative electrode containing one or more negative active materials described above (block 204). Certain aspects of manufacturing positive electrodes are described in U.S. Pat. No. 7,135,252 issued on Nov. 14, 2006, which is incorporates by reference herein in its entirety for the purpose of describing positive active materials and methods of manufacturing positive electrodes containing these materials. Furthermore, certain aspects of manufacturing negative electrodes are described in U.S. patent application Ser. No. 12/437,529 filed on May 7, 2009, which is incorporated by reference herein in its entirety for the purpose of describing negative active materials and methods of manufacturing negative electrodes.

In certain embodiments, fabrication of the positive electrode (operation 202) may include deposition of an active layer on the current collector using a number of deposition techniques, such as deposition with a doctor blade, a set of rollers, or other mechanisms. The active layer often also includes a binder and a conductive additive. The binder is used to keep solid particle attached the surface of the current collector.

The thicknesses of the active layers as well as their compositions are typically determined by the battery design and particularly capacity requirements. One factor is the charge and discharge rates, usually expressed as a ratio of either charge or discharge current relative to the cell capacity. For example, a rate of 1 C represents a current that completely discharges/drains a fully charged cell with 1 hour. The rate of 2 C corresponds to a double of the 1 C current, and so on. In high rate applications, such as those associated with hybrid electrical vehicles, cells are cycled at rates greater than 1 C, usually as high as 10 C. Such applications require that the positive electrode allow rapid introduction of lithium ions into active layers and at the same time allow easy access of electrons from the current collector to the lithiation sites. Therefore, for high rate applications, relatively thinner active layers and relatively thicker current collectors are typically used in comparison with low and standard rate cells. Additionally, the amount of conductive additive is usually increased to provide for higher electronic conductivity of the active layers. As a result, less active material is used per cell volume leading to a lower overall cell capacity. On the other hand, cells for low rate applications often contain more active materials and can therefore possess a higher energy density.

The current collector of the positive electrode is normally a thin metallic foil made of highly conductive, but electrochemically stable material. Aluminum foil is a common example, but other positive substrates may also be used, such as stainless steel, titanium, nickel, and any other electrochemically compatible and conductive materials. The selection usually depends on the active material and the intrinsic maximum potential of the positive electrode. The thickness of the current collector is typically chosen based on the intended capacity and charge/discharge rates of the cell as discussed above. Typically, an aluminum foil of about 20-30 μm thickness can be used, however both thinner and thicker foils may be used, e.g., in the range of about 5 to 50 μm. The foil may be attached directly to the cell's positive terminal or to some intermediate conducting structure such as a current collection disk or tab. In one example, a case of the battery serves as the positive terminal.

The positive active material is typically held on the substrate with a binder. In certain embodiments, the active material represents a bulk of the positive electrode; for example about 60-95 weight percent of the active layer (i.e. excluding the substrate). Active materials are usually in the powder form with a mean particle diameter of between about 1 μm and 50 μm; more specifically, between about 3 and 30 μm. The selection of positive active materials depends on several considerations, such as cell capacity, safety requirements, intended cycle life, etc.

In certain embodiments, a positive active layer includes a conductive additive. Essentially any electro-conductive material that is chemically and electrochemically stable may be used in positive and negative electrodes. In some cases, the conductive additive is a carbonaceous material, such as coke, acetylene black, carbon black, Ketchen black, channel black, furnace black, lamp black and thermal black or carbon fibers, graphite in an amount up to 20 weight percent of the active layer, more specifically 1 to 10 weight percent. Additionally, conductive additives may comprise metallic flakes or particles of copper, stainless steel, nickel or other relatively inert metals, conductive metal oxides, such as titanium oxides or ruthenium oxides, or electronically-conductive polymers, such as polyaniline or polypyrrole. In one specific embodiment, the conductive material is a carbon black having a mean particle size of between 1 μm and 70 μm, more specifically between about 5 μm and 30 μm, is used in an amount of between about 1 and 5 weight percent of the total postive active layer. Conductive additives particles may have surface area on the order of about 100 m²/g or less. Higher amounts of conductive agent may be needed in certain designs such as those for high rate applications and those involving relatively thick electrodes.

A binder is used to hold the active material and the conductive agent on the substrate. Generally, a binder may be used in the amount of between about 2 and 25 weight percent of the active layer based on the solid content of the binder (i.e. excluding solvent). Binders may be soluble in aqueous or non-aqueous solvents, which are used during fabrication. Some examples of “non-aqueous binders” include poly(tetrafluoroethylene) (PTFE), poly(vinylidene fluoride) (PVDF), styrene-butadiene copolymer (SBR), acrylonitrile-butadiene copolymer (NBR) or carboxymethyl cellulose (CMC), polyacrylic, and polyethylene oxide, and combinations thereof. For example, 10-20 weight percent PVDF dissolved in N-methyl-2-pyrrolidinone (NMP) may be used. As another example, a combination binder using 1-10 weight percent of polytetrafluoroethylene (PTFE) and 1-15 weight percent of carboxymethylcpllulose (CMC) may be used relative to the total weight of the materials in the layer.

Examples of “aqueous binders” include carboxymethyl cellulose and poly (acrylic acid), and/or acrylonitrile-butadiene copolymer latex. One specific example of an aqueous binder is polyacrylamide in combination with at least one of the following copolymers: carboxylated styrene-butadiene copolymer and styrene-acrylate copolymer. The ratio of polyacrylamide to such copolymer may be between about 0.2:1 to about 1:1 on a dry weight basis. In another specific example, the aqueous binder may comprise a carboxylic acid ester monomer and a methacrylonitrile monomer.

In another specific example, the binder may include a fluoropolymer and a metal chelate compound. The fluoropolymer may be polymerized from fluorinated monomers, such as vinyl fluoride (VF), vinylidene fluoride (VdF), tetrafluoroethylene (TFE), trifluoroethylene (TrFE), chlorotrifluoroethylene (CTFE), fluorinated vinyl ethers, fluorinated alkyl acrylates/methacrylates, perfluoroolefins having 3-10 carbon atoms, perfluoro C1-C8 alkyl ethylenes and fluorinated dioxoles. The metal chelate compound may be in the form of a heterocyclic ring with an electron-pair-acceptor metal ion, such as titanium and zirconium ions, attached by coordinate bonds to at least two electron-pair-donor nonmetal ions, such as N, O, and S.

Returning to FIG. 2, fabrication of the positive electrode (operation 202) may start with preparation of a slurry that is later coated on a substrate. Generally, the slurry contains all materials of the positive active layer (e.g., positive active materials, binders, and conductive additives) and a solvent. The solvent may be chosen to achieve a desired viscosity during the deposition process. The conductive agent may require a separate dispersion operation, which would usually be performed by pre-mixing some binder and a conductive agent and then passing the resulting mixture through a dispersing system, such as a ball mill or a high-shear mixer. In certain embodiments, the operation takes hours and the slurry may be periodically tested using Hegman gauge to determine presence of un-dispersed conductive agent particles. Depending on the thickness of active layer, the maximum particle requirement may be set to between about 10 and 100 μm. Large particles may interfere with slurry deposition process and affect uniformity of electrical properties.

The remaining components (typically the active material and possibly some additional solvent) are then added into the slurry. The formulation of the slurry excluding the solvent (i.e. the solid content) at this point is usually representative of the resulting active layer. Typically the viscosity of the slurry is adjusted by adding solvent suitable for use with the deposition system. For many processes, a slurry viscosity of 5,000-40,000 cP is appropriate. When the desired viscosity is reached, the slurry is coated onto the current collector material and the solvent is removed by drying. A typical weight density of the dry positive active layer may be between about 0.001 g/cm² and 0.030 g/cm², more specifically between about 0.005 g/cm² and 0.010 g/cm², excluding substrate. For example, an electrode with two active layers each having a density of 0.020 g/cm² coated on a 30 μm aluminum substrate would have a total electrode density of about 0.048 g/cm².

Coating may be performed using a moving web comprising a current collector. For example, a web of aluminum foil having thickness of 10-30 μm and a width of between about 10 cm and 500 cm may be used. The web may be patch coated on both sides, each patch may be representative of the final electrode length. The uncoated gap between the plates may be used for attachment of battery terminals. Alternatively, a continuous coating may be applied on both or one side of the web,

The coated and dry plates are usually compressed to achieve a desired density of the active layer. The compressing may be done using a set of rollers configured to keep a certain pressure or provide a certain gap. The rollers may be heated to between about 60 and 120 degrees Centigrade. Moreover, the coated plates may be pre-heated to between about 60 and 120 degrees Centigrade making the active material layer more susceptible to uniform compression. The positive electrodes are usually compacted to a total thickness of between about 50-300 μm, including both active layers and a current collector. Typically, the porosity of compressed electrode is between about 20 and 50%, more specifically between about 30 and 40%. Finally, the compressed plates are cut to the electrodes of the required width and length. Battery terminals may be attached to the current collector either before or after the cutting.

In certain embodiments, fabrication of the negative electrode (operation 204) follows some of the steps outlined above. In other embodiments, a nanostructured negative active material is substrate-rooted as described in U.S. patent application Ser. No. 12/437,529 filed on May 7, 2009, which is incorporated by reference herein in its entirety for the purpose of describing substrate rooted nanostructures.

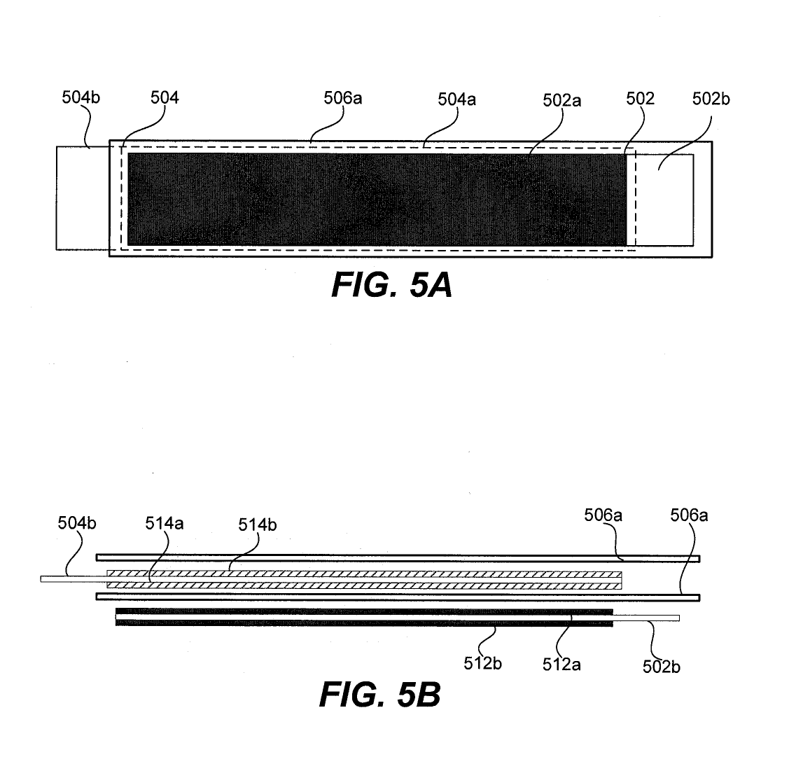

Once the two electrodes are fabricates, the process 200 continues with fabricating an electrode assembly (block 206). Electrodes are typically assembled into a stack or a jelly roll. FIG. 5A illustrates a side view of an aligned stack including a positive electrode 502, a negative electrode 504, and two sheets of the separator 506a and 506b in accordance with certain embodiments. The positive electrode 502 may have a positive active layer 502a and a positive uncoated substrate portion 502b. Similarly, the negative electrode 504 may have a negative active layer 504a and a negative uncoated substrate portion 504b. In many embodiments, the exposed area of the negative active layer 504a is slightly larger that the exposed area of the positive active layer 502a to ensure trapping of the lithium ions released from the positive active layer 502a by insertion material of the negative active layer 504a. In one embodiment, the negative active layer 504a extends at least between about 0.25 and 5 mm beyond the positive active layer 502a in one or more directions (typically all directions). In a more specific embodiment, the negative layer extends beyond the positive layer by between about 1 and 2 mm in one or more directions. In certain embodiments, the edges of the separator sheets 506a and 506b extend beyond the outer edges of at least the negative active layer 504a to provide electronic insulation of the electrode from the other battery components. The positive uncoated portion 502b may be used for connecting to the positive terminal and may extend beyond negative electrode 504 and/or the separator sheets 506a and 506b. Likewise, the negative uncoated portion 504b may be used for connecting to the negative terminal and may extend beyond positive electrode 502 and/or the separator sheets 506a and 506b.

FIG. 5B illustrates a top view of the aligned stack. The positive electrode 502 is shown with two positive active layers 512a and 512b on opposite sides of the flat positive current collector 502b. Similarly, the negative electrode 504 is shown with two negative active layer 514a and 514b on opposite sides of the flat negative current collector. Any gaps between the positive active layer 512a, its corresponding separator sheet 506a, and the corresponding negative active layer 514a are usually minimal to non-existent, especially after the first cycle of the cell. The electrodes and the separators are either tightly would together in a jelly roll or are positioned in a stack that is then inserted into a tight case. The electrodes and the separator tend to swell inside the case after the electrolyte is introduced and the first cycles remove any gaps or dry areas as lithium ions cycle the two electrodes and through the separator.

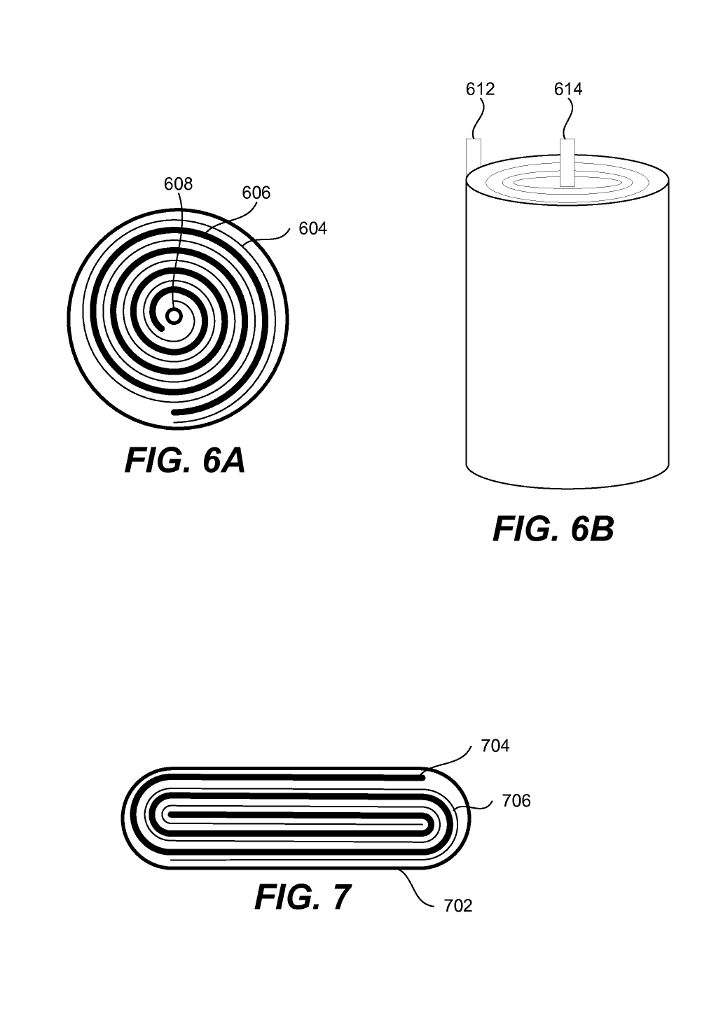

A wound design is a common arrangement. Long and narrow electrodes are wound together with two sheets of separator into a sub-assembly, sometimes referred to as a jellyroll, shaped and sized according to the internal dimensions of a curved, often cylindrical, case. FIG. 6A shows a top view of a jelly roll comprising a positive electrode 606 and a negative electrode 604. The white spaces between the electrodes represent the separator sheets. The jelly roll is inserted into a case 602. In some embodiments, the jellyroll may have a mandrel 608 inserted in the center that establishes an initial winding diameter and prevents the inner winds from occupying the center axial region. The mandrel 608 may be made of conductive material, and, in some embodiments, it may be a part of a cell terminal. FIG. 6B presents a perspective view of the jelly roll with a positive tab 612 and a negative tab 614 extending from the jelly roll. The tabs may be welded to the uncoated portions of the electrode substrates.

The length and width of the electrodes depend on the overall dimensions of the cell and thicknesses of active layers and current collector. For example, a conventional 18650 cell with 18 mm diameter and 65 mm length may have electrodes that are between about 300 and 1000 mm long. Shorter electrodes corresponding to low rate/higher capacity applications are thicker and have fewer winds.

A cylindrical design may be desirable for some lithium ion cells because the electrodes swell during cycling and exert pressure on the casing. A round casing may be made sufficiently thin and still maintain sufficient pressure. Prismatic cells may be similarly wound, but their case may bend along the longer sides from the internal pressure. Moreover, the pressure may not be even within different parts of the cells and the corners of the prismatic cell may be left empty. Empty pockets may not be desirable within the lithium ions cells because electrodes tend to be unevenly pushed into these pockets during electrode swelling. Moreover, the electrolyte may aggregate and leave dry areas between the electrodes in the pockets negative effecting lithium ion transport between the electrodes. Nevertheless, for certain applications, such as those dictated by rectangular form factors, prismatic cells are appropriate. In some embodiments, prismatic cells employ stacks rectangular electrodes and separator sheets to avoid some of the difficulties encountered with wound prismatic cells.

FIG. 7 illustrates a top view of a wound prismatic jellyroll. The jelly roll comprises a positive electrode 704 and a negative electrode 706. The white space between the electrodes is representative of the separator sheets. The jelly roll is inserted into a rectangular prismatic case. Unlike cylindrical jellyrolls shown in FIGS. 6A and 6B, the winding of the prismatic jellyroll starts with a flat extended section in the middle of the jelly roll. In one embodiment, the jelly roll may include a mandrel (not shown) in the middle of the jellyroll onto which the electrodes and separator are wound.

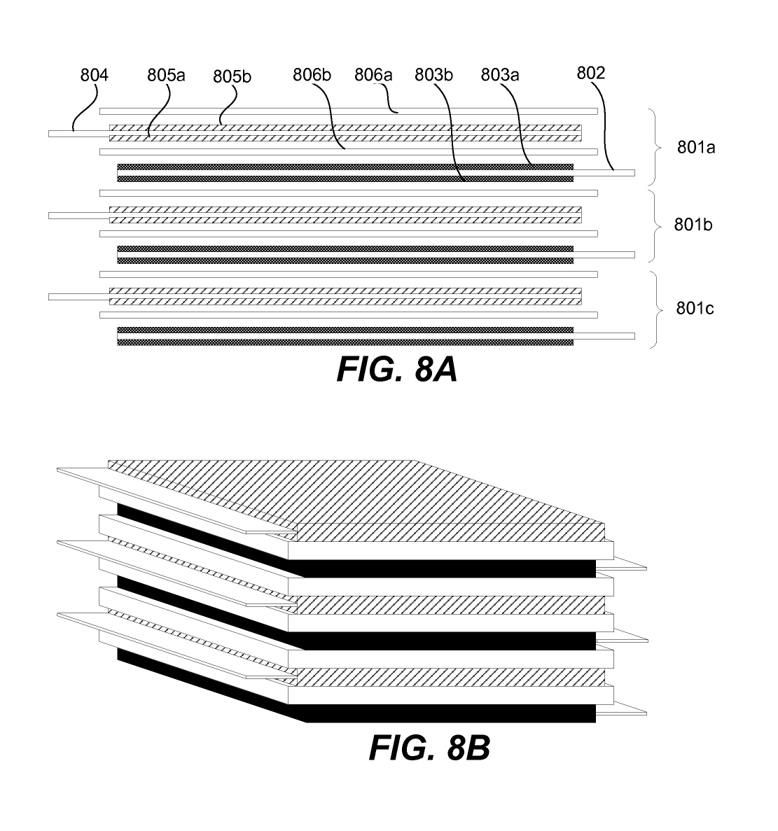

FIG. 8A illustrates a side view of a stacked cell including a plurality of sets (801a, 801b, and 801c) of alternating positive and negative electrodes and a separator in between the electrodes. One advantage of a stacked cell is that its stack can be made to almost any shape, and is particularly suitable for prismatic cells. However, such cell typically requires multiple sets of positive and negative electrodes and a more complicated alignment of the electrodes. The current collector tabs typically extend from each electrode and connected to an overall current collector leading to the cell terminal.

Once the electrodes are arranged as described above, the cell is filled with electrolyte. The electrolyte in lithium ions cells may be liquid, solid, or gel. The lithium ion cells with the solid electrolyte also referred to as a lithium polymer cells.

A typical liquid electrolyte comprises one or more solvents and one or more salts, at least one of which includes lithium. During the first charge cycle (sometimes referred to as a formation cycle), the organic solvent in the electrolyte can partially decompose on the negative electrode surface to form a solid electrolyte interphase layer (SEI layer). The interphase is generally electrically insulating but ionically conductive, allowing lithium ions to pass through. The interphase also prevents decomposition of the electrolyte in the later charging sub-cycles.

Some examples of non-aqueous solvents suitable for some lithium ion cells include the following: cyclic carbonates (e.g., ethylene carbonate (EC), propylene carbonate (PC), butylene carbonate (BC) and vinylethylene carbonate (VEC)), vinylene carbonate (VC), lactones (e.g., gamma-butyrolactone (GBL), gamma-valerolactone (GVL) and alpha-angelica lactone (AGL)), linear carbonates (e.g., dimethyl carbonate (DMC), methyl ethyl carbonate (MEC), diethyl carbonate (DEC), methyl propyl carbonate (MPC), dipropyl carbonate (DPC), methyl butyl carbonate (NBC) and dibutyl carbonate (DBC)), ethers (e.g., tetrahydrofuran (THF), 2-methyltetrahydrofuran, 1,4-dioxane, 1,2-dimethoxyethane (DME), 1,2-diethoxyethane and 1,2-dibutoxyethane), nitrites (e.g., acetonitrile and adiponitrile) linear esters (e.g., methyl propionate, methyl pivalate, butyl pivalate and octyl pivalate), amides (e.g., dimethyl formamide), organic phosphates (e.g., trimethyl phosphate and trioctyl phosphate), and organic compounds containing an S═O group (e.g., dimethyl sulfone and divinyl sulfone), and combinations thereof.

Non-aqueous liquid solvents can be employed in combination. Examples of the combinations include combinations of cyclic carbonate-linear carbonate, cyclic carbonate-lactone, cyclic carbonate-lactone-linear carbonate, cyclic carbonate-linear carbonate-lactone, cyclic carbonate-linear carbonate-ether, and cyclic carbonate-linear carbonate-linear ester. In one embodiment, a cyclic carbonate may be combined with a linear ester. Moreover, a cyclic carbonate may be combined with a lactone and a linear ester. In a specific embodiment, the ratio of a cyclic carbonate to a linear ester is between about 1:9 to 10:0, preferably 2:8 to 7:3, by volume.

A salt for liquid electrolytes may include one or more of the following: LiPF₆, LiBF₄, LiClO₄ LiAsF₆, LiN(CF₃SO₂)₂, LiN(C₂F₅SO₂)₂, LiCF₃SO₃, LiC(CF₃SO₂)₃, LiPF₄(CF₃)₂, LiPF₃(C₂F₅)₃, LiPF₃(CF₃)₃, LiPF₃(iso-C₃F₇)₃, LiPF₅(iso-C₃F₇), lithium salts having cyclic alkyl groups (e.g., (CF₂)₂(SO₂)₂ₓLi and (CF₂)₃(SO₂)₂ₓLi), and combination of thereof. Common combinations include LiPF₆ and LiBF₄, LiPF₆ and LiN(CF₃SO₂)₂, LiBF₄ and LiN(CF₃SO₂)₂.

In one embodiment the total concentration of salt in a liquid nonaqueous solvent (or combination of solvents) is at least about 0.3 M; in a more specific embodiment, the salt concentration is at least about 0.7M. The upper concentration limit may be driven by a solubility limit or may be no greater than about 2.5 M; in a more specific embodiment, no more than about 1.5 M.

A solid electrolyte is typically used without the separator because it serves as the separator itself. It is electrically insulating, ionically conductive, and electrochemically stable. In the solid electrolyte configuration, a lithium containing salt, which could be the same as for the liquid electrolyte cells described above, is employed but rather than being dissolved in an organic solvent, it is held in a solid polymer composite. Examples of solid polymer electrolytes may be ionically conductive polymers prepared from monomers containing atoms having lone pairs of electrons available for the lithium ions of electrolyte salts to attach to and move between during conduction, such as Polyvinylidene fluoride (PVDF) or chloride or copolymer of their derivatives, Poly(chlorotrifluoroethylene), poly(ethylene-chlorotrifluoro-ethylene), or poly(fluorinated ethylene-propylene), Polyethylene oxide (PEO) and oxymethylene linked PEO, PEO-PPO-PEO crosslinked with trifunctional urethane, Poly(bis(methoxy-ethoxy-ethoxide))-phosphazene (MEEP), Triol-type PEO crosslinked with difunctional urethane, Poly((oligo)oxyethylene)methacrylate-co-alkali metal methacrylate, Polyacrylonitrile (PAN), Polymethylmethacrylate (PNMA), Polymethylacrylonitrile (PMAN), Polysiloxanes and their copolymers and derivatives, Acrylate-based polymer, other similar solvent-free polymers, combinations of the foregoing polymers either condensed or cross-linked to form a different polymer, and physical mixtures of any of the foregoing polymers. Other less conductive polymers may be used in combination with the above polymers to improve strength of thin laminates include: polyester (PET), polypropylene (PP), polyethylene napthalate (PEN), polyvinylidene fluoride (PVDF), polycarbonate (PC), polyphenylene sulfide (PPS), and polytetrafluoroethylene (PTFE).

FIG. 9 illustrates a cross-section view of the wound cylindrical cell in accordance with one embodiment. A jelly roll comprises a spirally wound positive electrode 902, a negative electrode 904, and two sheets of the separator 906. The jelly roll is inserted into a cell case 916, and a cap 918 and gasket 920 are used to seal the cell. It should be note that in certain embodiments a cell is not sealed until after subsequent operations (i.e., operation 208). In some cases, cap 912 or case 916 includes a safety device. For example, a safety vent or burst valve may be employed to break open if excessive pressure builds up in the battery. In certain embodiments, a one-way gas release valve is included to release oxygen released during activation of the positive material. Also, a positive thermal coefficient (PTC) device may be incorporated into the conductive pathway of cap 918 to reduce the damage that might result if the cell suffered a short circuit. The external surface of the cap 918 may used as the positive terminal, while the external surface of the cell case 916 may serve as the negative terminal. In an alternative embodiment, the polarity of the battery is reversed and the external surface of the cap 918 is used as the negative terminal, while the external surface of the cell case 916 serves as the positive terminal. Tabs 908 and 910 may be used to establish a connection between the positive and negative electrodes and the corresponding terminals. Appropriate insulating gaskets 914 and 912 may be inserted to prevent the possibility of internal shorting. For example, a Kapton™ film may used for internal insulation. During fabrication, the cap 918 may be crimped to the case 916 in order to seal the cell. However prior to this operation, electrolyte (not shown) is added to fill the porous spaces of the jelly roll.

A rigid case is typically required for lithium ion cells, while lithium polymer cells may be packed into a flexible, foil-type (polymer laminate) case. A variety of materials can be chosen for the case. For lithium-ion batteries, Ti-6-4, other Ti alloys, Al, Al alloys, and 300 series stainless steels may be suitable for the positive conductive case portions and end caps, and commercially pure Ti, Ti alloys, Cu, Al, Al alloys, Ni, Pb, and stainless steels may be suitable for the negative conductive case portions and end caps.

The process 200 continues with formation cycling and activation of the positive material (block 208), which may involve one or more charge-discharge cycles performed at controlled rates, depths of charge and discharge, and optional rest periods. Formation cycling is associated with certain irreversible changes in the cell, such as formation of an SEI layer on the negative electrode, resulting in irreversible capacity losses (which when quantified are referred to as an irreversible capacity). As mentioned above, the activation involves converting at least a fraction of the inaction component into an active form. For example, a Li₂MnO₃ inactive material is activated when the cell is charged to at least about 4.4V. In certain embodiments, some of the inactive component (e.g., at least about 1% or more specifically at least about 5%, at least about 10%) remain in the inactive form even after the activation. Further, in certain embodiments, some of this residual inactive component (that is not converted during the initial activation) is later converted into the active form. Formation and activation may be performed simultaneously (e.g., during one or more initial cycles) or may be performed sequentially (e.g., formation followed by activation). For example, a cell may be charged to the activation level (e.g., a voltage of greater than 4.4V) during one of the formation cycles. In a specific embodiment, the cell is charged to the activation level in the first cycle (i.e., during the initial charge right after assembly). In other embodiments, formation is performed before activation, such that the charge cut-off voltage may be limited to less than about 4.4V during formation. After formation is performed, one or more activation cycles may follow.

It should be understood that the embodiments described herein embody electrochemical cells at various stages of fabrication and use, from initial construction through deployment in the end user's application and onward through the useful life of the cell. Regarding the fabrication process, the cells embodied herein may exist prior to formation cycling (operation 208), after formation cycling but prior to activation of the positive material (operation 210), after activation of the positive material, or at any other stages of fabrication.

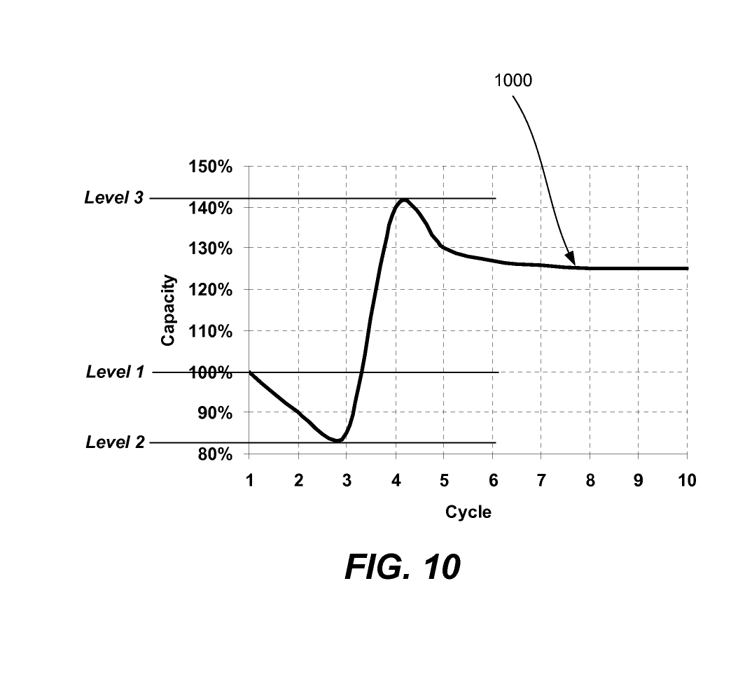

FIG. 10 is an illustrative discharge capacity profile 1000 for a cell going through initial formation cycling and activation cycling in accordance with certain embodiments. A discharge capacity of the first cycle is set as a reference point (at 100%). It should be noted that the first discharge capacity is usually lower than the first charge capacity. This type of capacity loss, which is not illustrated in FIG. 10, is typically expressed as a columbic efficiency. In certain embodiments, the columbic efficiency of the first cycle is at least about 80%, or more specifically at least about 90%.

The profile shown in FIG. 10 corresponds to the process in which formation continues during the first three cycles and activation is performed during the fourth cycle. The discharge capacity typically drops during the initial cycles (usually higher during the first cycles and then more gradually during subsequent cycles). As mentioned above, a drop in capacity is at least in part due to formation of an SEI layer that traps some lithium ions that would be otherwise available for cycling. In profile 1000, this drop is represented by the discharge capacity decreases from Level 1 in the first cycle to Level 2 in the third cycle. In the next cycle, which may still be considered a part of formation, the activation is performed, resulting in release of new lithium ions by the activated materials (e.g., two lithium ions for each Li₂MnO₃ molecule.) Profile 1000 shows substantial capacity increase to Level 3, which may result from additional lithium ions offsetting previous capacity losses of the negative electrode and introducing new active material into the positive electrode. The capacity may gradually decrease in subsequent cycles. However, in certain embodiments and as shown in FIG. 10, the initial capacity loss (from Level 1 to Level 2) is more than offset for a substantial number of cycles. Further, in certain embodiments and as shown in FIG. 10, a nominal capacity (shown after cycle 6 in FIG. 10) may be substantially higher than the initial capacity prior to activation.

### IV. CONCLUSION

Although the foregoing invention has been described in some detail for purposes of clarity of understanding, it will be apparent that certain changes and modifications may be practiced within the scope of the appended claims. It should be noted that there are many alternative ways of implementing the processes, systems and apparatus of the present invention. Accordingly, the present embodiments are to be considered as illustrative and not restrictive, and the invention is not to be limited to the details given herein.

What is claimed is:

1. An electrochemical cell comprising:
a negative electrode containing a nanostructured high capacity active material; and
a positive electrode containing a composite active material having an inactive component and an active component, wherein the inactive component is convertible to the active component when activated.

2. The electrochemical cell of claim 1, wherein the activation comprises a release of lithium ions having a columbic content of at least about 100 mAh/g based on the weight of the converted inactivate component.

3. The electrochemical cell of claim 1, wherein the activation comprises a release of lithium ions having a columbic content of at least about 300 mAh/g based on the weight of the inactive component.

4. The electrochemical cell of claim 1, wherein the amount of the inactive component in the positive electrode prior to activation is sufficient to approximately match the irreversible lithium insertion capacity of the negative electrode.

5. The electrochemical cell of claim 1, wherein a stoichiometric ratio of the active component to the inactive component prior to the activation is between about 1/10 and 10.

6. The electrochemical cell of claim 1,
wherein the active component comprises LiMO₂, wherein M comprises one or more ions with an average oxidation state of three selected from the group consisting of vanadium (V), manganese (Mn), iron (Fe), cobalt (Co), and nickel (Ni); and
wherein the inactive component is in the form of Li₂M′O₃, wherein M′ comprises one or more ions with an average oxidation state of four selected from the group consisting of manganese (Mn), titanium (Ti), zirconium (Zr), ruthenium (Ru), rhenium (Re), and platinum (Pt).

7. The electrochemical cell of claim 1, wherein the nanostructured active material comprises silicon-containing nanowires substrate rooted to a conductive substrate.

8. The electrochemical cell of claim 1, wherein the nanostructured active material comprises a core and a shell and wherein the material of the core is different from the material of the shell.

9. The electrochemical cell of claim 1, wherein the nanostructured active material comprises structures having an average aspect ratio of at least about 100 in a fully discharged state.

10. The electrochemical cell of claim 1, wherein the nanostructured active material comprises structures having an average cross-section dimension of between about 1 nanometer and 300 nanometers in a fully discharged state.

11. The electrochemical cell of claim 1, wherein the nanostructured active material comprises structures having an average length of at least about 100 micrometer in a fully discharged state.

12. The electrochemical cell of claim 1, wherein the nanostructured active material forms a layer having a porosity of less than about 75 percent.

13. The electrochemical cell of claim 1, wherein the negative electrode has a capacity to sufficient to lithiate all lithium ions available for transfer between the two electrodes after the activation of the inactive component.

14. A method of fabricating an electrochemical cell comprising a negative electrode with a nanostructured active material and a positive electrode with a composite active material comprising an inactive component and an active component, the method comprising:
activating at least a fraction of the inactive component by converting the fraction into an active form accompanied by release of lithium ions having a columbic content of at least about 100 mAh/g based on the weight of the fraction
wherein the negative electrode comprises an irreversibly inserted amount of lithium that is no less than the released lithium ions.

15. The method of claim 14, wherein at least a fraction of the irreversibly inserted amount of lithium ions is inserted into the negative electrode during the activation.

16. The method of claim 14, wherein the nanostructured active material having a reversible lithium insertion capacity of at least about 700 mAh/g and an irreversible lithium insertion capacity of at least about 200 mAh/g after at least 20 cycles.

17. The method of claim 14 further comprising:
aligning the negative electrode relative to the positive electrode to form an assembly selected from the group consisting of a jellyroll and a stack; and
encapsulating the assembly into a case,
wherein the activation is performed after the encapsulation of the assembly.

18. The method of claim 14, wherein the activation comprises charging the electrochemical cell to at least about 4.4V.

19. The method of claim 14, wherein the activation is performed after at least one cycle of the electrochemical cell.

20. A battery pack comprising an electrochemical cell that includes
a negative electrode containing a nanostructured high capacity active material; and
a positive electrode containing a composite active material having an inactive component and an active component, wherein the inactive component is convertible to the active component when activated.
